(19) United States
(12) Patent Application Publication
(10) Pub. No.: US 2025/0390635 A1
(43) Pub. Date: Dec. 25, 2025

(54) Method for Adapting Numerical Simulations of Mechanical Structures using Vibration Measurements

(71) Applicant: Wolfgang Klippel, Dresden (DE)

(72) Inventor: Wolfgang Klippel, Dresden (DE)

(21) Appl. No.: 19/241,826

(22) Filed: Jun. 18, 2025

(30) Foreign Application Priority Data
Jun. 19, 2024 (DE) 102024001995.2

(51) Int. Cl. G06F 30/23; G06F 30/17; G06F 111/10

(52) U.S. Cl. CPC G06F 30/23; G06F 30/17; G06F 2111/10

(57) ABSTRACT

A method for verifying the vibration simulation of a mechanical structure and optimizing the elasticity and damping parameters used in the model by analyzing a vibration waveform measured on the surface of an existing prototype of this mechanical structure without physical contact. The correlation between the simulated and measured vibration waveforms is evaluated using an elasticity and damping metric, with optimized elasticity and damping parameters determined in an iterative simulation process. These metrics capture distinct properties of the vibrational shape: the elasticity metric employs the local wave number on the surface of the structure, while the damping metric assesses the decline of the envelope of traveling waves moving away from the excitation point and returning. This method is beneficial for adapting the complex modulus of elasticity in the numerical simulation of mechanical structures made from different material components that radiate sound across a broad frequency range.

### CROSS REFERENCE TO RELATED APPLICATIONS

This application claims the benefit of German Patent Application No. DE 102024001995.2, filed Jun. 19, 2024, the content of which is hereby incorporated by reference in its entirety.

### FIELD OF INVENTION

The invention discloses a method for adapting and optimizing vibration simulation (e.g., FEA) using a measuring device (e.g., a laser vibration scanner) that determines the vibration behavior of a structure on an accessible measuring surface without contact. The goal is to adjust the free model parameters that describe the geometry and material properties of the structure on the measuring surface to minimize the deviation between the simulated and measured vibration waveforms. This invention is particularly beneficial for designing loudspeakers and other structures that emit airborne sound across a wide frequency range, incorporating multiple materials whose properties cannot be accurately determined using current methods.

### BACKGROUND OF THE INVENTION

Numerical simulation methods have proven effective for designing mechanical structures, particularly in assessing vibration behavior and sound radiation. These methods rely on an abstract physical model with adjustable free parameters P that must be customized to fit the specific mechanical structure. The Finite Element Analytical Model (FEA) meets the requirements of the differential equation

Kx(t)+Dx(t)+M\ddot{x}(t)=f(t)

where the state vectors x(t) and f (t) represent the local deflection and external excitation forces acting on the structure, respectively. The free parameters P in this model are the three FEA matrices K, D, and M, which describe the stiffness, damping, and mass of all elements in the FEA in general. These analytical parameters, K, D, and M, are directly related to physical parameters that more accurately model the structure's geometry and the properties of the materials.

One advantage of numerical simulation is its capacity to quickly assess the core functionality of a new concept based on geometric assumptions and estimated material parameters. Following the provision of a prototype, the numerical simulation can be validated through non-destructive and non-contact vibration measurements.

The patent publication US 2023/0304969 A1 describes a method for three-dimensional scanning of vibrations on a plate or shell using a laser vibration scanner with a demodulation technique.

Deviations between simulation and measurement can be minimized by adjusting the free parameters of the FEA. Various methods have been developed to adapt these parameters under the concept of Finite Element Model Updating (FEMU), optimizing the analytical FEA matrices K, D, and M. A comparative study by V. Arora, “Comparative study of finite element model updating methods,” Journal of Vibration Control 17(13), pages 2013-2039, outlines the advantages and disadvantages of different methods.

Some FEMU methods involve a modal analysis of the measured and simulated vibration data, followed by pairing the respective calculated modes with a MAC measure (Modal Assurance Criterion) and a robust optimization procedure for the analytical FEA matrices K, D, and M. J. Matalevich describes in, “Vibration and Modal Analysis Basics” URL: https://indico.jlab.org/event/98/contributions/7450/attachments/6319/8367/6T_-_Vibration_and_Modal_Analysis_Basics.pdf the measurement of transfer functions and the basics of modal analysis.

However, a laser vibration scanner, based on the current state of the art, can only scan the vibration behavior of a structure on an optically accessible measurement surface A_{M}, which typically is only a fraction of the overall structural surface A. As a result, the experimentally determined modes do not always align with the analytical modes, leading to errors during the pairing process needed to optimize the free parameters. Additionally, modes with similar natural frequencies or low-quality factors may not be distinguishable.

R. Lin and D. Ewins, in “Analytical Model Improvement using Frequency Response Function,” Mechanical Systems and Signal Processing (1994)8(4), 437-458, developed an alternative FEMU method (FRF) that gets around modal analysis and directly optimizes the FEA matrices by using transfer functions, which establish the relationship between an excitation force F and the deflection x at points r within the measuring surface A_{M}. The deflection of all accessible elements of the structure is measured with a stationary excitation force supplied at a fixed location; thus, measurements are skipped at points inaccessible to the sensor and are replaced by interpolated data. However, significant errors in optimization can occur when these approximated measurement data cover a wide area of the structure. One advantage of the FRF method is that it requires measurement data at relatively few excitation frequencies, which are evenly distributed across the relevant frequency range. The FRF method, like other perturbation methods, requires that the relative deviations between the parameters P(i) used in the simulation and the optimal parameters P*, which explain the measured values, remain relatively small. Even for materials with high damping and with measurement data affected by noise, challenges arise in conditioning and solving the system of equations.

The FRF and other established optimization methods can also be applied to derived physical parameters (e.g., modulus of elasticity), which reduce the number of unknowns and enhances the conditioning of the system of equations as well as the robustness of the method; see R. M. Lin and J. Zhu in “Model updating of damped structures using FRF data”, Mechanical systems and signal processing, Vol. 20, 2006, No. 8, pp. 2200-2218, ISSN 0888-3270.

Some free parameters of the model can be provided by alternative techniques that require no vibrometer. 3D geometry laser scanners can accurately capture the shapes of structures, achieving sufficient precision for most finite element analysis (FEA) applications. A precision balance can measure the mass of these components and calculate the density of the materials. However, these structures may need to be disassembled into individual components before measurements can be applied.

The dynamic determination of the complex modulus of elasticity according to ASTM standard E 756-93 typically requires flat specimens clamped like beams and excited mechanically or acoustically to induce bending vibrations. However, this method is time-consuming, prone to errors, and only reliably measures data at low frequencies. Although these values can be extrapolated to higher frequencies, this process often results in significant errors when applied to materials such as paper, fabric, rubber, polymers, and composites.

CN 1 11 751 200 B describes a method for dynamically measuring the modulus of elasticity of a material, considering the mean pressure and temperature of the sample.

Since the materials used in loudspeakers emit sound across the entire audio frequency range, W. Cardenas and W. Klippel propose a method in “Optimal Material Parameter Estimation by Fitting Finite Element Simulations to Loudspeaker Measurements”, 144th Meeting of the Audio Eng. Society (May 2018), Number: 9928, https://www.aes.org/e-lib/browse.cfm?clib=19445, that directly fits the complex modulus of elasticity of the materials used in loudspeaker simulation to a measured vibration waveform on the sound radiating surface (e.g., diaphragm, dust cap, surround) across a wide frequency range. This method extracts modes from both the simulated and measured vibration data, pairs these modes, and minimizes the deviations in the complex eigenvalues and the Modal Assurance Criteria (MAC). However, the iterative optimization process can become stuck in suboptimal minima of the error measure. This technique cannot handle high-loss materials commonly used in loudspeaker design.

### SUMMARY OF THE INVENTION

The invention aims to develop a method that verifies the numerical simulation of the vibrational behavior of an existing mechanical structure using a non-contact and non-destructive measuring device while optimizing the free elasticity parameters P_{E} and the damping parameters P_{D} of the employed physical model. These free elasticity parameters P_{E} (r,f) and damping parameters P_{D}(r,f) include the real part E_{R}(r,f) and the imaginary part E_{I}(r,f) of the complex modulus of elasticity

$$\underline{E} ( r , f ) = {E}_{R} ( r , f ) + j {E}_{I} ( r , f )$$

of the materials used in the structure at point r and at the excitation frequency f. This method accommodates the wide range of elasticity and damping values across the entire audio frequency range commonly found in loudspeaker materials. The method can also be used to optimize the thickness and other geometric parameters of the structure that influence its elasticity. Additionally, the effect of vibrating air particles close to the sound radiating surface on the overall structure damping can be validated using this method.

The measuring device determines a vibration waveform xₘ(r,f) using a sensor that monitors deflection, velocity, or other mechanical state variables on a measuring surface A_{M}, which can be a portion of the structure's surface. The measured vibration waveform xₘ(r,f) is measured under constant excitation conditions as a complex function of sensing point r and the excitation frequency f.

The simulation calculates the complex vibration waveform xₛ(r, f) on the measurement surface A_{M} using classical FEA methods or alternative numerical models that provide a more detailed description of wave propagation, damping, and acoustic load. Mechanical vibration excitation is achieved by consistently applying external forces or moments at the same excitation point re with constant strength throughout the measurement and simulation.

The verification of the numerical simulation and the adjustment of the free elasticity parameters P_{E} (r,f,i) and damping parameters P_{D} (r,f,i) are conducted through an iterative process. Throughout this process, elasticity values E(r,f,i) and damping values D(r,f,i) are calculated based on the measured and simulated vibration waveforms. The discrepancy between the measured and simulated values is assessed using error measures, which serve as the basis for generating correction factors to adjust the elasticity parameters P_{E}(r,f,i+1) and damping parameters P_{D}(r,f,i+1).

According to the invention, the elasticity and damping values are calculated using metrics that capture essential, and above all, independent characteristics of the complex vibration waveform in wave space. The real part of the complex wave number, which is inversely proportional to the wavelength, serves as an indicator of elasticity, while the imaginary part represents energy loss (dissipation) within the mechanical structure. The imaginary part of the wave number illustrates the exponential decay of the traveling waves' envelope over distance. These metrics largely remain independent of the vibration waveform's amplitude. In this regard, the invention stands apart from experimental modal analysis, which separates the total vibration into modes characterized by complex natural frequencies and orthogonal eigenvectors, utilizing the resonance peaks in the amplitude response to determine modal natural frequencies and loss factors. In the present invention, the amplitude frequency response is not used as a metric since both elasticity and damping influence amplitude. However, the vibration waveform's amplitude can serve other purposes, such as evaluating the signal-to-noise ratio and suppressing distorted measurement data in the calculated metrics.

A further feature of the invention is that the vibration waveform x(r,f) from measurement or simulation is decomposed on the measuring surface A_{M} into a standing vibration waveform and a residual, propagating vibration waveform.

In the stationary state, the standing vibration waveform x_{sw}(r,f) consists of two wave components traveling in opposite directions with equal amplitude. These components establish a location-independent phase in the complex vibration waveform and do not effectively transmit energy through the spatial coordinate r.

The residual vibration described by x_{pw}(r,f) reflects the remaining aspect of the complex vibration waveform, with its phase varying by location and consisting of traveling waves that decrease in amplitude. These traveling waves carry energy from the excitation point re (source), where the voice coil in the loudspeaker exerts force on the structure, to the damping resistors distributed throughout the structure (sink), where mechanical energy is transformed into heat. This situation is utilized in the invention to establish the local damping metric, which measures the amplitude drop over r by analyzing the local gradient of the traveling wave envelopes. Calculating the envelopes of the traveling waves departing from the excitation point re and returning to the same location r is crucial, and their difference is used to determine the damping values. This process accounts for the influences of structural geometry, reflections at material boundaries, and the near field around the excitation point re on the traveling wave envelopes.

The elasticity metric is constructed using the local real wave number, derived from the local gradient of the imaginary phase of a complex analytical vibration waveform. This complex-analytic waveform, similar to the complex-analytic signal in signal theory, is a complex-valued function defined over the spatial dimension, where its imaginary part represents the Hilbert transform of the real part. This waveform comprises only partial waves propagating in the same direction. It is beneficial to select the propagation direction that maximizes the total power of all partial waves, resulting in an improved signal-to-noise ratio.

Thus, the two metrics for elasticity and damping utilize orthogonal information that establishes a monotonic relationship with the elasticity or damping parameter at location r and frequency f. While monotonicity is crucial for avoiding suboptimal solutions in iterative optimization, a nearly linear relationship is advantageous for reducing the number of simulations required. Further nonlinear transformations, particularly the elasticity metric, can linearize the connection between the metrics and the modulus of elasticity, thus accelerating the convergence of the iterative method to the error minimum.

The signal-to-noise ratio can be enhanced by averaging the sensor signals during measurements and the local metrics across the structural components in the measurement area. Furthermore, the impact of noise can be minimized by averaging the correction factors within specific frequency bands.

### SHORT DESCRIPTION OF THE DRAWINGS

FIG. 1 shows a generalized block diagram for the optimal fitting of the complex modulus of elasticity in a numerical simulation of the vibration behavior according to the invention.

FIG. 2 shows a generalized block diagram for generating elasticity values using an elasticity metric in accordance with the invention.

FIG. 3 shows a generalized block diagram for generating damping values using a damping metric in accordance with the present invention.

FIG. 4 shows the real and imaginary parts, as well as the envelope of a simulated vibration waveform of a loudspeaker.

FIG. 5 shows the real and imaginary parts, as well as the envelope of the standing wave part of the simulated vibration waveform of a loudspeaker.

FIG. 6 shows the real and imaginary parts, as well as the envelope of the traveling waves of a loudspeaker propagating in the positive r-direction.

FIG. 7 shows the envelopes of the traveling waves from a loudspeaker moving in both positive and negative directions.

### DETAILED DESCRIPTION OF THE INVENTION

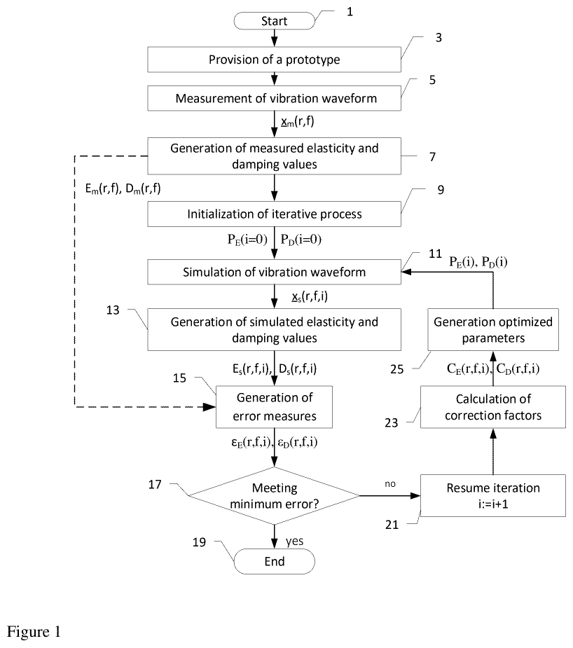

FIG. 1 illustrates the key steps in optimizing the complex modulus E(r,f) and other free model parameters within the numerical simulation of a mechanical structure's vibration behavior, as described in the invention. The first step, following the start (1) of the procedure, provides a physical prototype of the mechanical structure (3), which has its surface vibrations measured on the measuring surface A_{M}. In the second step (5), external forces or moments excite the mechanical structure under defined conditions (e.g., varying frequency f, constant amplitude, and fixed position re). The deflection x, velocity v, or another physical state variable is sampled at the appropriate local resolution while considering the occurring wavelengths and the Nyquist criterion. The vibration waveform xₘ(r,f) is calculated from the measured values, serving as a complex transfer function between a constant excitation force F(rₑ) and the measured state variable xₘ(r,f) at the measurement point r. This vibration waveform is typically complex, where the imaginary part indicates damping within the structure.

In a further step (7), local measured values with metrics are derived from the measured vibration waveform xₘ(r,f), where the elasticity values Eₘ(r,f) represent elasticity, and the damping values Dₘ(r,f) indicate losses at location r on the structure. According to the inventive idea, the elasticity metric and damping metric describe different properties of the measured vibration waveform, serving as independent characteristics of elasticity and damping, respectively, when adjusting the corresponding free model parameters.

In the following procedure step (9), the iterative adjustment process is initialized (i=0), and the initial parameters P_{E}(i=0) and P_{D} (i=0) for modeling are defined. These initial parameters include information (e.g., geometry, density) that can be measured with high precision using non-vibrational techniques on the prototype, along with estimated values for other material properties (e.g., the complex modulus of elasticity) that are either unknown or difficult to measure.

These initial parameters are utilized in the subsequent step (11) to compute the simulated vibration waveform xₛ(r,f,i) through a numerical model (FEA).

In the next step (13), the simulated elasticity values Eₛ(r,f,i) and the damping values Dₛ(r,f,i) are calculated from the simulated vibration waveform xₛ(r,f,i) using the same metrics applied to the measured elasticity values Eₘ(r,f) and damping values Dₘ(r,f) in step (7).

In the next step (15), local error measures ε(r,f,i) are generated to evaluate the discrepancy between the simulated and measured vibration waveforms in decibels, which includes the relative ratio of the elasticity values
and damping values

$${ε}_{E} ( r , f , i ) = 20 log ( \frac{{E}_{s} ( r , f , i )}{{E}_{m} ( r , f )} )$$

$${ε}_{D} ( r , f , i ) = 20 log ( \frac{{D}_{s} ( r , f , i )}{{D}_{m} ( r , f )} ) .$$

These error measures evaluate the iteration process in step (17). For example, the mean quadratic error (MSE)

$$\overline{ε} ( f , i ) = \sqrt{\frac{1}{2 {N}_{r}} {\sum }_{∀ r} {( {ε}_{E} ( r , f , i ) )}^{2} + {( {ε}_{D} ( r , f , i ) )}^{2}}$$

are calculated and assessed with a termination criterion. Once the MSE value has sufficiently approached the minimum, it is advisable to conclude the iterative process (19).

If the reduction of the MSE value was significant in the last iteration step, a further iteration is conducted with an incremented index i: =i+1 (21).

In the next step (23), correction factors for the previously used elasticity parameters P_{E} (i−1) and free damping parameters P_{D} (i−1) are determined based on the local error measures

$${C}_{E} ( r , f , i ) = 1 {0}^{- {ε}_{E} ( r , f , i - 1 ) / 20}$$

$${C}_{D} ( r , f , i ) = 1 {0}^{- {ε}_{D ( r , f , i - 1 ) / 20}}$$

and in the next step (25) for generating optimized parameters P_{E} (i) or P_{D} (i):

$${P}_{E} ( r , f , i ) = {C}_{E} ( r , f , i ) {P}_{E} ( r , f , i - 1 )$$

$${P}_{D} ( r , f , i ) = {C}_{E} ( r , f , i ) {P}_{D} ( r , f , i - 1 )$$

For example, optimized values for the real and imaginary parts of the complex E-module E can be calculated

$${E}_{R} ( r , f ) = {C}_{E} ( r , f , i ) {E}_{R} ( r , f , i - 1 )$$

$${E}_{I} ( r , f , i ) = {C}_{D} ( r , f , i ) {E}_{I} ( r , f , i - 1 )$$

and can be used in a further iteration starting with numerical simulation (11).

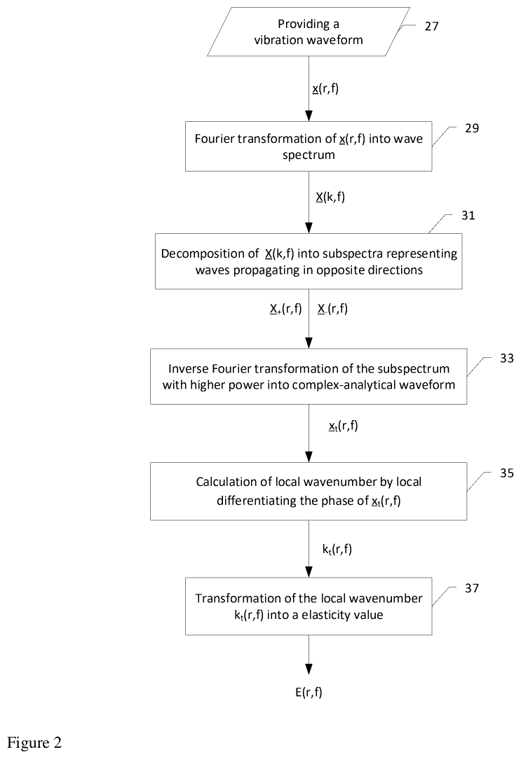

FIG. 2 shows a generalized block diagram of the elasticity metric, which generates the elasticity values Eₘ(r,f) and Eₛ(r,f) from the measured and simulated vibrational waveforms (27), respectively.

In the first step (29), the corresponding vibration waveform x(r,f), whether measured or simulated, is transformed into a wave spectrum X(k,f) as a function of the wavenumber k with the help of a discrete Fourier transform (DFT):

$$\underline{X} ( k , f ) = DFT \{ \underline{x} ( r , f ) \}$$

In the next step (31), the wave spectrum X(k,f) is divided into two subspectra, each containing positive and negative wavenumbers.

$$\underline{X} ( k , f ) = {\underline{X}}_{+} ( k , f ) + \underline{{X}_{-}} ( k , f )$$

whereby

$$\begin{matrix}{\underline{X}}_{+} ( k , f ) = \underline{X} ( k , f ) ( 1 + sign ( k ) ) / 2 \\ {\underline{X}}_{-} ( k , f ) = \underline{X} ( k , f ) ( 1 - sign ( k ) ) / 2\end{matrix} .$$

In the next step (33), the sub-spectrum with greater total power is selected

$${\underline{X}}_{t} ( k , f ) = \{ \begin{matrix}{\underline{X}}_{+} ( k , f ) f \ddot{u} r {\int }_{∀ k} {{\underline{X}}_{+} ( k , f )}^{2} dk > {\int }_{∀ k} {{\underline{X}}_{-} ( k , f )}^{2} dk \\ {\underline{X}}_{-} ( k , f ) f \ddot{u} r {\int }_{∀ k} {{\underline{X}}_{+} ( k , f )}^{2} dk \leq {\int }_{∀ k} {{\underline{X}}_{-} ( k , f )}^{2} dk\end{matrix}$$

and the complex analytical vibration waveform xₜ(r,f) calculated with the inverse DFT:

$${\underline{x}}_{t} ( r , f ) = D F {T}^{- 1} \{ {\underline{X}}_{t} ( k , f ) \}$$

Subsequently, the local real wave number kₜ(r,f) in step (35) is generated by local differentiation of the phase of the complex vibration waveform:

$${k}_{t} ( r , f ) = \vert \frac{d arg ( {\underline{x}}_{t} ( r , f )}{d r} \vert$$

In the last step (37), assuming that bending vibrations dominate the shape of the waveform, the local real wave number kₜ(r,f) is converted into an elasticity metric that is proportional to the real part E_{R} of the modulus of elasticity near an operating point:

$$E ( r , f ) = {{k}_{𝔩} ( r , f )}^{- 4} ∝ {E}_{R} ( r , f )$$

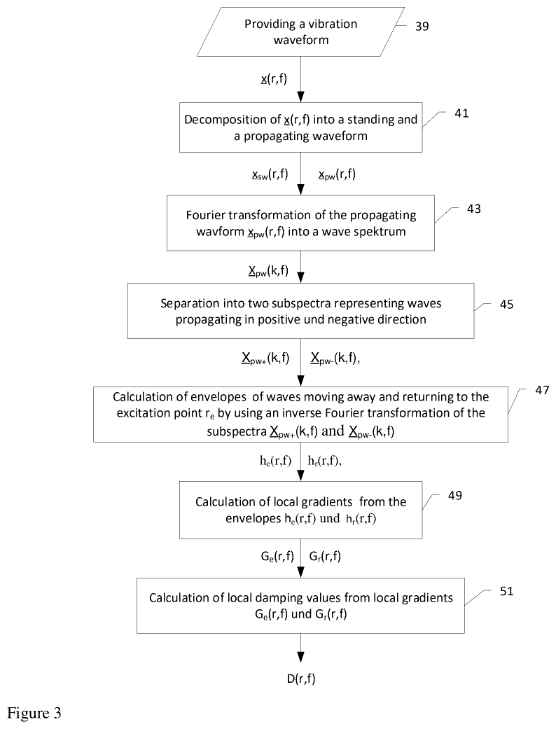

FIG. 3 shows a generalized block diagram of the damping metric utilized to generate the damping values Dₘ(r,f) and Dₛ(r,f) from the measured and simulated vibration waveform (39), respectively.

In the first step (41), the respective vibration waveform x(r,f), whether measured or simulated, is decomposed into a standing vibration waveform x_{sw}(r,f) and a residual propagating vibration waveform x_{pw}(r,f) through wave analysis:

$$\underline{x} ( r , f ) = {\underline{x}}_{δ w} ( r , f ) + {x}_{pw} ( r , f )$$

For example, the correlation technique developed by B. F. Skinner Feeny, “A Complex Orthogonal Decomposition for Wave Motion Analysis,” J. of Sound and Vibration 310 (1-2) 77-90 (2008), can be applied for this purpose.

In the next step (43), the residual propagating vibration waveform x_{pw}(r,f) is transformed into a wave spectrum:

$${\underline{X}}_{p w} ( k , f ) = DFT \{ {\underline{x}}_{pw} ( r , f ) \}$$

Then, in step (45), the propagating wave spectrum x_{pw}(k,f) is divided into two subspectra

$${\underline{X}}_{p w} ( k , f ) = {\underline{X}}_{p w +} ( k , f ) + {\underline{X}}_{pw -} ( k , f ) ,$$

through which the spectrum

$${\underline{X}}_{p w +} ( k , f ) = {\underline{X}}_{p w} ( k , f ) ( 1 + sign ( k ) ) / 2$$

represents the propagation of residual traveling waves in the positive r-direction and the spectrum

$${\underline{X}}_{p w} ( k , f ) = {\underline{X}}_{p w} ( k , f ) ( 1 - sign ( k ) ) / 2$$

describes the propagation in the negative r-direction.

In the following step (47), the two subspectra are transformed into complex-analytical vibration waveforms using an inverse DFT

$${\underline{x}}_{pw +} ( r , f ) = {DFT}^{- 1} \{ {\underline{X}}_{p w +} ( k , f ) \}$$

$${\underline{x}}_{pw -} ( r , f ) = {DFT}^{- 1} \{ {\underline{X}}_{pw -} ( k , f ) \}$$

and their absolute values represent the envelopes of these traveling waves in the positive and negative r-direction:

$${h}_{p w +} ( r , f ) = \vert {\underline{x}}_{pw +} ( r , f ) \vert$$

$${h}_{pw -} ( r , f ) = \vert {\underline{x}}_{pw -} ( r , f ) \vert$$

Considering the position of the excitation point re, where a force is applied to the mechanical structure and the source of the traveling waves is located, the next step (49) can be the gradient of the envelope of the waves propagating away from the source.

$${G}_{e} ( r , f ) = \{ \begin{matrix}\frac{d {h}_{p w +} ( r , f )}{d r} & r > {r}_{e} \\ \frac{d {h}_{pw -} ( r , f )}{d r} & r \leq {r}_{e}\end{matrix}$$

The gradient of the wave envelope returning to the source can be determined:

$${G}_{r} ( r , f ) = \{ \begin{matrix}\frac{d {h}_{pw -} ( r , f )}{d r} & r > {r}_{e} \\ \frac{d {h}_{p w +} ( r , f )}{d r} & r \leq {r}_{e}\end{matrix}$$

In the final step (51), the difference between the two gradients is converted into a damping metric that is proportional to the imaginary part E_{I} of the modulus of elasticity near the operating point:

$$D ( r , f ) = {G}_{r} ( r , f ) - {G}_{e} ( r , f ) ∝ {E}_{I} ( r , f )$$

To enhance the signal-to-noise ratio of the measured values and the robustness of the iterative process, it is beneficial to average the local and frequency-dependent elasticity errors ε_{E}(r,f,i) along with the damping errors ε_{D}(r,f,i) in a local region r(m_{c}) with homogeneous material properties on the measuring surface A_{M} and within a frequency band (e.g., one octave):

$${\overline{ε}}_{E} ( r ( {m}_{c} ) , {f}_{b} , i ) = \frac{1}{{N}_{r} ( {m}_{c} ) {N}_{b} ( {f}_{b} )} {\sum }_{j = 1}^{{N}_{r} ( {m}_{c} )} {\sum }_{m = 1}^{{N}_{b} ( {f}_{b} )} {ε}_{E} ( {r}_{j} , {f}_{m} , i )$$

$${\overline{ε}}_{D} ( r ( {m}_{c} ) , {f}_{b} , i ) = \frac{1}{{N}_{r} ( {m}_{c} ) {N}_{b} ( {f}_{b} )} {\sum }_{j = 1}^{{N}_{r} ( {m}_{c} )} {\sum }_{m = 1}^{{N}_{b} ( {f}_{b} )} {ε}_{D} ( {r}_{j} , {f}_{m} , i )$$

The corresponding correction factors C_{E}(r(m_{c}), f_{b}, i) and C_{D}(r(m_{c}), f_{b}, i) are calculated from these mean values and used to adjust the elasticity and damping parameters. For instance, in the case of a loudspeaker, spatial averaging is performed separately in three regions: m_{c}=1, 2, and 3, specifically for the rubber surround, the paper cone, and the dust protection dome.

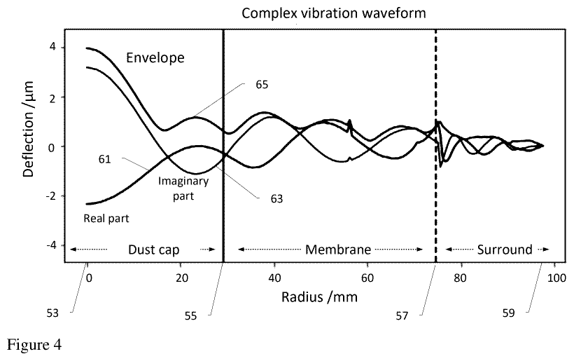

FIG. 4 illustrates the simulated vibration waveform x(r,f) of the sound-emitting components in the radial direction r of an axially symmetrical loudspeaker. The center (53) of the dust cap is positioned at a radius r=0 mm. The voice coil (55) produces an excitation force at the junction between the dust cap and the paper cone at position rₑ=28 mm. At radius r=75 mm (57), the paper cone connects to a rubber surround, which is attached to the chassis (59) at r=95 mm. The real part (61) and the imaginary part (63) describe the envelope (65) of the vibration waveform.

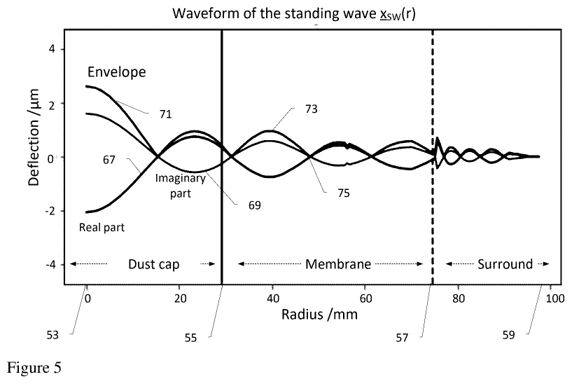

FIG. 5 shows the standing wave fraction x_{sw}(r,f) of the simulated vibration waveform x (r,f) of the loudspeaker in FIG. 4. The real part (67), the imaginary part (69), and the envelope (71) share a maximum (antinode, 73) at radius r=38 mm, and a minimum (node, 75) at radius r=45 mm. Thus, the standing wave effectively does not transport any power in the stationary state.

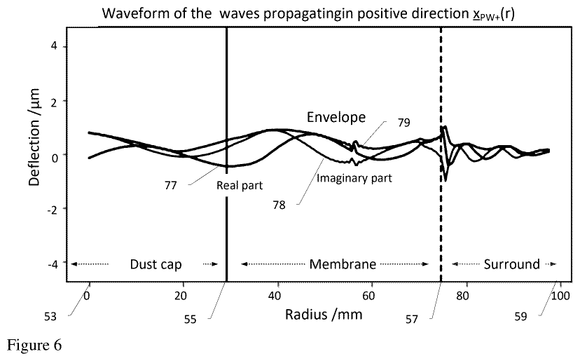

FIG. 6 illustrates the wave component x_{pw+}(r,f) traveling in a positive direction along the simulated vibration waveform x(r,f) of the loudspeaker depicted in FIG. 4. The real part (77), the imaginary part (78), and the envelope (79) each reach their maxima at different locations. Consequently, these propagating waves transmit power radially outward.

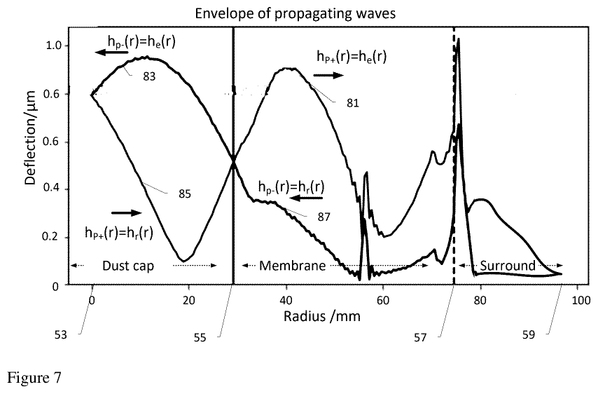

FIG. 7 shows the envelopes hₑ(r) and hᵣ(r) of the waves (83, 81) moving away from the voice coil at excitation point re (55) and the returning waves (85, 87), respectively. The difference between these two envelopes indicates the power loss of the propagating waves due to material damping and is used to calculate the damping metric in the invention.

### Advantages of the Invention

The new method for optimizing the free elasticity and damping parameters of a numerical vibration simulation does not require detailed information about the physical model used. In particular, no restrictive assumptions are made regarding the type of damping (e.g., viscous, proportional, linear, homogenous, isotropic) or its physical causes (e.g., material properties, hysteresis, air movements). Thus, the method can be applied to adapt the complex modulus of elasticity for various material components, as well as the elasticity and damping parameters of other models with different complexities and accuracies (e.g., the number and distribution of nodes in the mesh).

The necessary input information includes vibration data as a function of one or two spatial coordinates and frequency, along with the positions of the component boundaries and the excitation points. Confidential information from new product development, such as detailed 3D geometry data and material properties, is not required for parameter optimization.

The invention can be applied to mechanical structures that allow access only to a limited measuring area (A_{M}) for non-contact and non-destructive vibration measurements.

The numerical simulation of vibration data can be performed using commercially available FEA products in a short time, as only a sparse frequency resolution of the vibration data (e.g., third-octave) within the relevant frequency range is necessary. However, this resolution is typically inadequate for modal analysis.

The invention determines the elasticity and damping parameters as functions of frequency and can be applied to materials where these parameters are not constant. For mechanical structures made entirely of a homogeneous material with frequency-independent elasticity and damping, it is possible to optimize the free material parameters using only a few measurement locations at a particular excitation frequency.

In contrast to prior art, no restrictive assumptions are made regarding the number and properties of the material components in the structure. This approach allows for consideration of unknown influences arising from shaping, the use of adhesive joints, and other manufacturing techniques. The invention can also be applied to materials with extreme properties, such as textiles treated with viscous impregnation to achieve very high damping in the vibrating structure. These materials are used, for instance, in loudspeakers to attain a smooth frequency response and high sound quality.

Additionally, the invention can optimize the geometry of the mechanical structure, as well as the density and other properties of the materials used.

1. Method for verifying vibration simulations of a mechanical structure and optimizing the used free elasticity parameters P_{E} (r,f) and damping parameters P_{D}(r,f) in an iterative process; wherein the method consists of the following steps:
I. Provision of an actual prototype of the mechanical structure and measurement of a complex vibration waveform xₘ(r,f) as a function of location r and excitation frequency f, utilizing a non-contact measuring device that represents a physical state variable across a measuring surface A_{M} on surface A of the prototype;
II. Generation of measured elasticity values Eₘ(r,f), based on the measured vibration waveform xₘ(r,f), utilizing an elasticity metric that establishes a monotonic relationship between the elasticity values Eₘ(r,f) and a local elasticity of the structure at the location r on the measuring surface A_{M} and at frequency f;
III. Generation of measured damping values Dₘ(r,f) is based on the measured vibration waveform xₘ(r,f), utilizing a damping metric that establishes a monotonic relationship between the damping values Dₘ(r,f) and a local damping of the structure at location r on the measuring surface A_{M}, and at frequency f, where both the elasticity metric and the damping metric capture independent features of the complex vibration waveform xₘ(r,f);
IV. Initialization of the iterative optimization process and the initial determination of the elasticity parameters P_{E} (r,f,i=0) and damping parameters P_{D} (r,f,i=0), utilizing existing knowledge about the geometry and material properties of the mechanical structure;
V. Numerical simulation of the physical state variable and determination of a simulated vibration waveform xₛ(r,f,i) on the measuring surface A_{M}, utilizing the elasticity parameters P_{E} (r,f,i) and the damping parameters P_{D} (r,f,i) through an iteration i;
VI. Generation of simulated elasticity values Eₛ(r,f,i) based on the simulated vibration waveform xₛ(r,f,i) using the elasticity metric outlined in step II;
VII. Generation of local elasticity errors EE (r,f,i), which describe the discrepancy between the measured elasticity values Eₘ(r,f) and the simulated elasticity values Eₛ(r,f,i);
VIII. Generation of simulated damping values Dₛ(r,f,i) based on the simulated state variable xₛ(r,f,i) using the damping metric in step III;
IX. Generation of local damping errors ε_{D}(r,f,i), which describe the discrepancy between the measured damping values Dₘ(r,f) and the simulated damping values Dₛ(r,f,i);
X. Completion occurs in the iterative process when the local elasticity errors ε_{E}(r,f,i) and damping errors ε_{D}(r,f,i) meet predefined conditions; otherwise, the calculation of optimized elasticity parameters P_{E} (r,f,i+1) and optimized damping parameters P_{D} (r,f,i+1) is based on the elasticity errors ε_{E}(r,f,i) or damping errors ε_{D}(r,f,i) in a subsequent iteration i: =i+1, which can be resumed with numerical simulation at the step V.

2. The method of claim 1, wherein
the elasticity metric describes a local wave number kₜ(r,f) at least at one point on the measuring surface A_{M} or a quantity derived from it; and
the damping metric describes the local losses resulting from the local change of an envelope h(r,f) of at least one residual traveling wave at one point on the measuring surface A_{M}.

3. The method of claim 1, wherein
the elasticity parameters P_{E} (r,f,i) and damping parameters P_{D} (r,f,i) correspond to a real part and an imaginary part of a complex modulus of elasticity E(r,f,i), respectively, at the location r within the measuring surface A_{M} at the excitation frequency f and the iteration i;
a correction factor C_{E}(r,f,i) is calculated from the elasticity error ε_{E}(r,f,i) and is applied to the elasticity parameters P_{E} (r,f,i); and
a correction factor C_{D}(r,f,i) is derived from the damping error ε_{D}(r,f,i) and applied to the damping parameters P_{D} (r,f,i).

4. Method according to claim 2, where the elasticity metric comprises the measured and simulated elasticity values Eₘ(r,f) or Eₛ(r,f,i) derived from the measured or simulated vibration waveform, respectively, according to the following steps:
I. Fourier transform of the respective vibration waveform x(r,f) as a function of the location r into a wave spectrum X(k,f) as a function of wavenumber k using exponential basis functions;
II. Calculation of a complex-analytical vibration waveform xₜ(r,f) as a function of the location r from the wave spectrum X(k,f);
III. Calculation of a local wavenumber kₜ(r,f) as a local gradient of a phase of the complex-analytical vibration waveform xₜ(r,f); and
IV. Transformation of the local wave number kₜ(r,f) into the corresponding elasticity value E(r,f).

5. Method according to claim 4, where the complex-analytical vibration waveform xₜ(r,f) is calculated following these steps:
I. Decomposition of the wave spectrum X(k,f) into subspectra X₊(k,f) and X₋(k,f), with the subspectra describing wave propagation in opposite directions; and
II. Calculation of a complex-analytical vibration waveform x(r,f) through applying an inverse Fourier transform to the subspectrum that has the highest total power.

6. Method according to claim 2, where the damping metric is the measured damping value Dₘ(r,f) or the simulated damping value Dₛ(r,f,i) from the measured or simulated vibration waveform, respectively, according to the following steps:
I. Decomposition of the respective vibration waveform x(r,f) into a standing vibration waveform x_{pw}(r,f) with a location-independent phase and a propagating vibration waveform x_{pw}(r,f) with a variable phase, wherein the propagating vibration waveform x_{pw}(r,f) represents the residual traveling waves on the structure;
II. Fourier transformation of the propagating vibration waveform x_{pw}(r,f) into a propagating wave spectrum x_{pw}(k,f); and
III. Calculation of the corresponding damping value D(r,f) derived from the propagating wave spectrum x_{pw}(k,f).

7. Method according to claim 6, in which the calculation of the respective damping value D(r,f) from the propagating wave spectrum x_{pw}(k,f) is carried out through the following steps:
I. Providing an excitation point re, where the excitation point re refers to the location where power is supplied to the structure by an external source;
II. Decomposition of the propagating wave spectrum x_{pw}(k,f) into two subspectra, X_{pw+}(k,f) and X_{pw-}(k,f), and the inverse Fourier transform of these subspectra into complex-analytical vibration waveforms x_{pw+}(r,f) and x_{pw-}(r,f), which describe the propagation of the residual traveling waves in a positive or negative direction, respectively;
III. Calculation of an outgoing envelope hₑ(r,f) of the residual traveling waves moving away from the excitation point re based on the complex-analytical vibration waveforms x_{pw+}(r,f) and x_{pw-}(r,f);
IV. Calculation of an incoming envelope hᵣ(r,f) of the residual traveling waves returning to the excitation point re based on the complex-analytical vibration waveforms X_{pw+}(r,f) and x_{pw-}(r,f);
V. Calculation of a local gradient Gₑ(r,f) of the outgoing envelope hₑ(r,f) and a local gradient Gᵣ(r,f) of the incoming envelope hᵣ(r,f); and
VI. Calculation of the local damping values D(r,f), which is defined as the difference between the local gradients Gₑ(r,f) and Gᵣ(r,f) of the outgoing and incoming envelopes, respectively, at the same location r.

8. Method according to claim 3, in which a correction of the elasticity parameters P_{E} (r,f,i) and the damping parameter P_{D} (r,f,i) of the numerical simulation is performed with the following steps:
I. Averaging the local elasticity errors ε_{E}(r,f,i) within a local region r(m_{c}) that has homogeneous material properties on the measuring surface A_{M}, and utilizing the mean value to calculate a correction factor C_{E}(r,f,i), which is applied to the elasticity parameters P_{E} (r,f,i) in this region;
II. Calculating the average damping error ε_{D}(r,f,i) in a local region r(m_{c}) with uniform material properties on the measuring surface A_{M} and using this error to determine a correction factor C_{D}(r,f,i), which is applied to the damping parameter P_{D} (r,f,i) in this area;
III. Averaging the local elasticity error ε_{E}(r,f,i) over a frequency band f_{b}, in which the frequency dependence of the material on the measuring surface A_{M} can be neglected, and using the mean value for calculating the correction factor C_{E}(r,f,i), which is applied to the elasticity parameter P_{E} (r,f,i) in this frequency band; and
IV. Averaging the damping error ε_{D}(r,f,i) within a frequency band f_{b}, where the frequency dependence of the material on the measuring surface A_{M} can be ignored, and to use the mean value for calculating the correction factor C_{D}(r,f,i), which is applied to the damping parameter P_{D} (r,f,i) in this frequency band.
